(19) United States
(12) Patent Application Publication
(10) Pub. No.: US 2024/0022108 A1
(43) Pub. Date: Jan. 18, 2024

(54) CIRCUIT POWER SUPPLY MANAGEMENT METHOD AND SYSTEM FOR FLOWMETER, AND FLOWMETER

(71) Applicant: Goldcard Smart Group Co., Ltd., Zhejiang (CN)

(72) Inventors: Yuejian FANG, Zhejiang (CN); Gengwei ZHANG, Zhejiang (CN); Yiheng CHEN, Zhejiang (CN)

(73) Assignee: Goldcard Smart Group Co., Ltd., Zhejiang (CN)

(21) Appl. No.: 18/253,237

(22) PCT Filed: Nov. 15, 2021
(86) PCT No.: PCT/CN2021/130768

§ 371 Date: May 17, 2023

(30) Foreign Application Priority Data
Dec. 28, 2020 (CN) 202011583095.6

(51) Int. Cl. H02J 9/00; G01F 15/00

(52) U.S. Cl. CPC H02J 9/002; G01F 15/00

(57) ABSTRACT

A circuit power supply management method and system for a flowmeter, and a flowmeter. The method includes: obtaining an intermittent circuit with a highest priority in an application list as a circuit to be run; obtaining a first priority and a first power of the circuit to be run; obtaining a currently available second power, and running the circuit to be run if the second power is greater than or equal to the first power, or obtaining, from a running queue, a third power with a priority lower than a priority of the circuit to be run; running the circuit to be run if a sum of the second power and the third power is greater than or equal to the first power, or if the sum of the second power and the third power is less than the first power, obtaining, from the application list, an intermittent circuit with a priority lower than the priority of the circuit to be run, as the circuit to be run and performing the step of obtaining the first priority and the first power of the circuit to be run. With the method, prioritized execution of an intermittent circuit with a high priority can be realized, and the requirement for simultaneous running of functional circuits is met, and meanwhile there is no need to add an extra intrinsically safe power supply, the cost is low and the circuit is simple.

### CROSS-REFERENCE TO RELATED APPLICATIONS

The present application is a national stage of International Application No. PCT/CN2021/130768, filed on Nov. 15, 2021, which claims priority to Chinese Patent Application No. 202011583095.6, filed with the China National Intellectual Property Administration on Dec. 28, 2020 and entitled “CIRCUIT POWER SUPPLY MANAGEMENT METHOD AND SYSTEM FOR FLOWMETER, AND FLOWMETER”. Both of the aforementioned applications are hereby incorporated by reference in their entireties.

### TECHNICAL FIELD

The present application relates to the field of circuit management technologies and, in particular, to a circuit power supply management method and system for a flowmeter, and a flowmeter.

### BACKGROUND

The running environment of a flowmeter is harsh, and requirements for safety are very high. Thus, it is necessary to meet explosion-proof intrinsic safety requirements. Since an output power of an intrinsically safe power supply (intrinsically safe power supply) is very limited, it cannot meet the requirements of simultaneous running of respective functional circuits in a product. An existing practice is to increase the number of intrinsically safe power supplies to increase a total output power to meet the power supply requirements.

Although increasing the number of intrinsically safe power supplies can increase the output power, the cost of intrinsically safe power supplies is high, which will increase a price of an entire product and reduce the product's market competitive advantage. In addition, increasing the number of intrinsically safe power supplies will complicate a design of an input circuit of the power supply. The input circuit of each power supply requires a DC-DC voltage conversion, power supply isolation and a circuit protection design, a size of a PCB needs to be increased, and a design difficulty is also increased. Moreover, increasing the number of intrinsically safe power supplies complicates field installation wiring.

To sum up, it is necessary to provide a circuit power management method and system for a flowmeter, and a flowmeter, which can meet the requirements for simultaneous running of functional circuits without need for adding an extra intrinsically safe power supply and thus provide a low cost and a simple circuit.

### SUMMARY

In order to solve the above problems, the present application provides a circuit power supply management method and system for a flowmeter, and a flowmeter.

In a first aspect, the present application provides a circuit power supply management method for a flowmeter, including:
obtaining an intermittent circuit with a highest priority in an application list as a circuit to be run;
obtaining a first priority and a first power of the circuit to be run;
obtaining a currently available second power, and running the circuit to be run if the second power is greater than or equal to the first power, or
obtaining, from a running queue, a third power of an intermittent circuit with a priority lower than a priority of the circuit to be run if the second power is less than the first power;
running the circuit to be run if a sum of the second power and the third power is greater than or equal to the first power, or
if the sum of the second power and the third power is less than the first power, obtaining, from the application list, an intermittent circuit with a priority lower than the priority of the circuit to be run, as the circuit to be run and performing the step of obtaining the first priority and the first power of the circuit to be run.

Preferably, before the obtaining the intermittent circuit with the highest priority in the application list as the circuit to be run, the method further includes:
performing a classification on a power supply circuit in the flowmeter, the classification includes: a constant power supply circuit and an intermittent circuit; and
prioritizing all of intermittent circuits.

Preferably, the obtaining, from the running queue, the third power of the intermittent circuit with the priority lower than the priority of the circuit to be run if the second power is less than the first power, including:
determining, from the running queue, all of intermittent circuits with priorities lower than the priority of the circuit to be run, as circuits to be calculated if the second power is less than the first power; and
determining a sum of powers of all the circuits to be calculated as the third power.

Preferably, the running the circuit to be run if the sum of the second power and the third power is greater than or equal to the first power, including:
sequentially releasing, in accordance with priority from low to high, intermittent circuits with priorities lower than the first priority in the running queue if the sum of the second power and the third power is greater than or equal to the first power; and
running the circuit to be run.

Preferably, before the obtaining, from the application list, the intermittent circuit with the priority lower than the priority of the circuit to be run, as the circuit to be run, the method further includes:
performing the step of obtaining the intermittent circuit with the highest priority in the application list as the circuit to be run if there is, in the application list, no intermittent circuit with the priority lower than the priority of the circuit to be run.

Preferably, after the running the circuit to be run, the method further includes:
deleting the circuit to be run that has been run from the application list; and
performing the step of obtaining the intermittent circuit with the highest priority in the application list as the circuit to be run.

Preferably, after the sequentially releasing, in accordance with priority from low to high, the intermittent circuits with the priorities lower than the first priority in the running queue, the method further includes:
adding the released intermittent circuits with the priorities lower than the first priority to the application list.

Preferably, the intermittent circuits in the application list are sorted in accordance with their priorities from high to low;
where the intermittent circuits with a same priority are sorted in accordance with power from low to high.

In a second aspect, the present application provides a circuit power supply management system for a flowmeter, including: a control module, a plurality of power supply control circuits and a plurality of intermittent circuits;
the number of the power supply control circuits is the same as the number of the intermittent circuits, and the intermittent circuits are connected to the control module through the power supply control circuits; and
the control module is configured to: obtain an intermittent circuit with a highest priority in an application list as a circuit to be run, where intermittent circuits with a same priority are sorted in accordance with power from low to high; obtain a first priority and a first power of the circuit to be run; obtain a currently available second power, and run the circuit to be run through the power supply control circuit if the second power is greater than or equal to the first power, or obtain, from a running queue, a third power of the intermittent circuits with a priority lower than a priority of the circuit to be run, and run the circuit to be run through the power supply control circuit if a sum of the second power and the third power is greater than or equal to the first power.

Preferably, the power supply control circuit includes: a first resistor, a second resistor and a triode;
one end of the first resistor is connected to an emitter of the triode and a power source, and the other end of the first resistor is connected to a base of the triode and one end of the second resistor; and
a collector of the triode is connected to the intermittent circuit, and the other end of the second resistor is connected to the control module.

In a third aspect, the present application provides a flowmeter, including: a constant power supply circuit and the above-mentioned circuit power supply management system for the flowmeter.

Advantages of the present application are that: by obtaining the intermittent circuit with the highest priority in the application list as the circuit to be run, running the circuit to be run in the application list according to the currently available second power and the sum of the second power and the third power, or sequentially releasing the intermittent circuits with the priorities lower than the first priority in the running queue in accordance with the priority from low to high and then running the circuit to be run, or selecting from the application list the intermittent circuits with the priority lower than the priority of a current circuit to be run and continuing the comparison, prioritized execution of an intermittent circuit with a high priority can be realized, so that the requirement for simultaneous running of functional circuits is met, and meanwhile there is no need to add an extra intrinsically safe power supply, the cost is low and the circuit is simple.

### BRIEF DESCRIPTION OF DRAWINGS

By reading the following detailed descriptions of the preferred embodiments, various other advantages and benefits will become apparent to those of ordinary skill in the art. The accompanying drawings are for the purpose of illustrating preferred embodiments only and are not considered as a limitation to the present application. Moreover, same components are denoted by a same reference sign in the whole accompanying drawings. In the accompanying drawings:

FIG. 1 is a schematic diagram of steps of a circuit power supply management method for a flowmeter according to the present application.

FIG. 2A and FIG. 2B are schematic flowcharts of a circuit power supply management method for a flowmeter according to the present application.

FIG. 3 is a schematic diagram of a circuit power supply management system for a flowmeter according to the present application.

FIG. 4 is a schematic diagram of a power supply control circuit of a circuit power supply management system for a flowmeter according to the present application.

### DESCRIPTION OF EMBODIMENTS

Exemplary embodiments of the present disclosure will be described in more detail below with reference to the accompanying drawings. Although exemplary embodiments of the present disclosure are shown in the accompanying drawings, it should be understood that the present disclosure may be achieved in various forms and should not be limited by the embodiments set forth herein. On the contrary, these embodiments are provided to understand the present disclosure thoroughly, and the scope of the present disclosure will be fully conveyed to those skilled in the art.

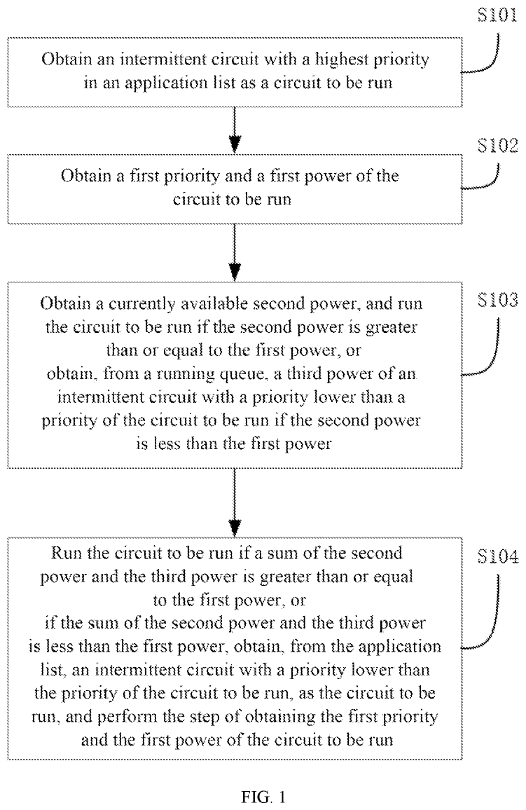

In a first aspect, a circuit power supply management method for a flowmeter is provided according to an embodiment of the present application, as shown in FIG. 1, including:
S101, obtain an intermittent circuit with a highest priority in an application list as a circuit to be run;
S102, obtain a first priority and a first power of the circuit to be run;
S103, obtain a currently available second power, and run the circuit to be run if the second power is greater than or equal to the first power, or obtain, from a running queue, a third power of an intermittent circuit with a priority lower than a priority of the circuit to be run if the second power is less than the first power; and
S104, run the circuit to be run if a sum of the second power and the third power is greater than or equal to the first power, or if the sum of the second power and the third power is less than the first power, obtain, from the application list, an intermittent circuit with a priority lower than the priority of the circuit to be run, as the circuit to be run and perform the step of obtaining the first priority and the first power of the circuit to be run.

Intermittent circuits in the application list are sorted in accordance with their priorities from high to low; where the intermittent circuits with a same priority are sorted in accordance with power from low to high.

The application list includes intermittent circuits that need performing functions. Once an intermittent circuit in the application list enters the running queue and starts to perform a function, this intermittent circuit is deleted from the application list.

Running the circuit to be run further includes: updating the second power. After completion of running a circuit in the running queue, the following is further included: stopping supplying power to this running-completed circuit, deleting this running-completed circuit from the running queue, and updating the second power.

Before the obtaining the intermittent circuit with the highest priority in the application list as the circuit to be run, the method further includes: performing a classification on a power supply circuit in the flowmeter, where the classification includes: a constant power supply circuit and an intermittent circuit; and prioritizing all of intermittent circuits. Constant power supply means that the circuit (a functional circuit) is always working during the whole running process. Intermittent power supply means that the functional circuit works only when conditions are met, and here refers in particular to a circuit that can be used for power supply scheduling, that is, the circuit, as the intermittent circuit, that can stop running.

The obtaining, from the running queue, the third power of the intermittent circuit with the priority lower than the priority of the circuit to be run if the second power is less than the first power, including: determining, from the running queue, all of intermittent circuits with priorities lower than the priority of the circuit to be run, as circuits to be calculated if the second power is less than the first power; and determining a sum of powers of all the circuits to be calculated as the third power.

The running the circuit to be run if the sum of the second power and the third power is greater than or equal to the first power including: sequentially releasing, in accordance with priority from low to high, intermittent circuits with priorities lower than the first priority in the running queue if the sum of the second power and the third power is greater than or equal to the first power; and running the circuit to be run. Releasing an intermittent circuit with a priority lower than the first priority in the running queue represents that the intermittent circuit with the priority lower than the first priority in the running circuits stop working.

After the sequentially releasing, in accordance with priority from low to high, the intermittent circuits with the priorities lower than the first priority in the running queue, the method further includes: adding the released intermittent circuits with the priorities lower than the first priority to the application list.

Before the obtaining, from the application list, the intermittent circuit with the priority lower than the priority of the circuit to be run, as the circuit to be run, the method further includes: performing the step of obtaining the intermittent circuit with the highest priority in the application list as the circuit to be run if there is, in the application list, no intermittent circuit with the priority lower than the priority of the circuit to be run.

After the running the circuit to be run, the method further includes:
deleting the circuit to be run that has been run from the application list; and
performing the step of obtaining the intermittent circuit with the highest priority in the application list as the circuit to be run.

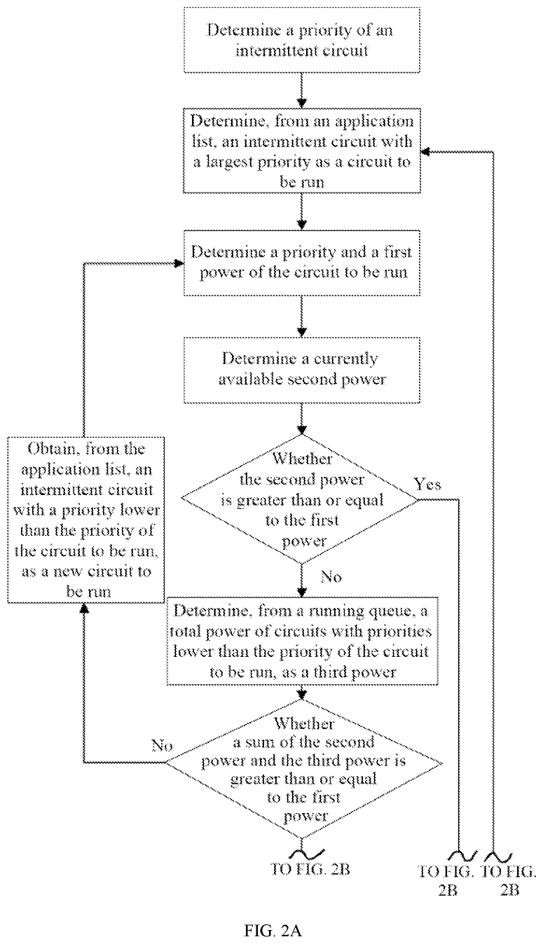

As shown in FIG. 2A and FIG. 2B, embodiments of the present application are further illustrated below.

A power management task is used to manage circuits in the running queue and in the application list.

Each functional circuit in a flowmeter is classified in accordance with a constant power supply and an intermittent power supply to find out intermittent circuits. For an intermittent circuit, a power supply control circuit, as a power supply switch, is directly added to each intermittent power supply circuit and control module, so as to perform the power supply or power off operation on the intermittent circuit.

A priority is defined for an intermittent circuit according to a timeliness of the power supply response. The higher the timeliness is required, the higher the priority is. Intermittent circuits with a same priority, are sorted in accordance with that the lower the power, the higher the priority.

An initial state of the intermittent circuit at power-on reset is a power off state. When a certain or some intermittent circuits are required to work, an application for power supply is made in the control module to the power management task, and the intermittent circuits that apply for power supply are stored in the application list. The power management task schedules the intermittent circuits in the application list according to a current load situation. If the current load situation allows, the intermittent circuit will be added to the running queue to perform power supply operations on the intermittent circuit; if the current load situation does not allows, this circuit is in a waiting state and added to the application queue. This circuit cannot run until application for power supply is approved as power requirements in the power supply are met after other circuits finish running and request a release of power supply.

When the intermittent circuit under approved application finishes running, a power supply request is released to the power management task, after the power management task releases the power supply to the circuit, the intermittent circuit is deleted from the running queue; if the application list is not empty, a power supply scheduling strategy is performed continuously, and power is supplied to intermittent circuits that meet the requirements.

Specifically, the intermittent circuits are grouped according to the timeliness of the power supply response, and the priorities are grouped from high to low. A group of intermittent circuits with low priorities can only be executed after a group of intermittent circuits with high priorities are executed. In a group of intermittent circuits with a same priority, the intermittent circuits are prioritized in accordance with a size of the power of the power supply. The smaller the power of the power supply, the higher the priority of the intermittent circuit.

The application list and the running queue are initialized, and initial values of them are null. When the intermittent circuit needs to be run, a power supply request is sent to the power management task, and the intermittent circuit that needs to be run is stored in the application list; and the intermittent circuit with the highest priority is obtained from the application list as the circuit to be run. A power P of the circuit to be run is taken as a first power.

A currently available power P0 is calculated as a second power according to a power of an intrinsically safe power supply and a power of the constant power supply circuit. The power management task compares the currently available power P0 with the first power P of the circuit to be run. If P0≥P, the circuit to be run is added to the running queue, the second power P0=P0−P is updated, and a power supply application is approved.

If P0<P, circuits with priorities lower than the priority of the circuit to be run in the running queue are obtained. If there are circuits with the priorities lower than the priority of the circuit to be run in the running queue, a sum of circuit powers released by these circuits is calculated as a third power. If the third power can meet an requested power, that is, the third power is greater than or equal to the first power, or a sum of the third power and the second power is greater than or equal to the first power, then these circuits are sequentially stopped in accordance with the priority from low to high, with power released, and these circuits are deleted from the running queue and added to the application queue; the power supply application of the circuit to be run is approved, and the circuit to be run is added to the running queue, and is deleted from the application queue. Another intermittent circuit is obtained from the application list in accordance with the priority and subsequent steps are performed until the application queue is empty, and the traversal ends.

When execution of the intermittent circuit finishes, application for releasing the power supply request is made to the power management task. A value of the second circuit P0 is updated by the power management task, P0=P0+P (P is a power of this circuit), and this circuit is deleted from the running queue. If the application queue is not empty, another intermittent circuit is obtained from the application list in accordance with the priority and subsequent steps are performed.

If release of a circuit power still does not meet a power of a circuit with a currently highest priority, that is, the sum of the third power and the second power is less than the first power, the application for power supply is not approved, and the circuit to be run is added back to the application list. Afterwards, an intermittent circuit with a priority lower than a priority of the circuit added back to the application list is obtained from the application list as the circuit to be run, the currently available power P0 is calculated as the second power, and subsequent steps are performed. That is, when the sum of the third power and the second power is less than the first power, the intermittent circuit with the priority lower than the priority of the current circuit to be run is selected from the application list as a new circuit to be run, and then the obtaining of the first power of this new circuit to be run and the currently available second power, as well as the subsequent steps, is performed, which will not be repeated here.

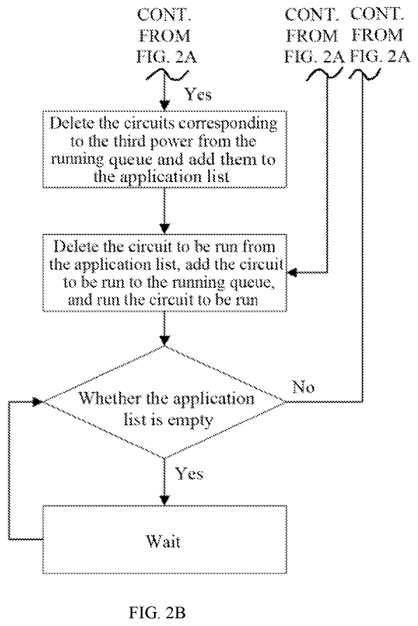

In a second aspect, as shown in FIG. 3, a circuit power supply management system for a flowmeter is provided according to an embodiment of the present application, including: a control module 100, a plurality of power supply control circuits 200 and a plurality of intermittent circuits 300.

The number of the power supply control circuits 200 is the same as the number of the intermittent circuits 300, and the intermittent circuits 300 are connected to the control module 100 through the power supply control circuits 200.

The control module 100 is configured to: obtain the intermittent circuit 300 with a highest priority in an application list as a circuit to be run, where intermittent circuits with a same priority are sorted in accordance with power from low to high; obtain a first priority and a first power of the circuit to be run; obtain a currently available second power, and run the circuit to be run through the power supply control circuit 200 if the second power is greater than or equal to the first power, or obtain, from a running queue, a third power of the intermittent circuits with a priority lower than a priority of the circuit to be run, and run the circuit to be run through the power supply control circuit 300 if a sum of the second power and the third power is greater than or equal to the first power.

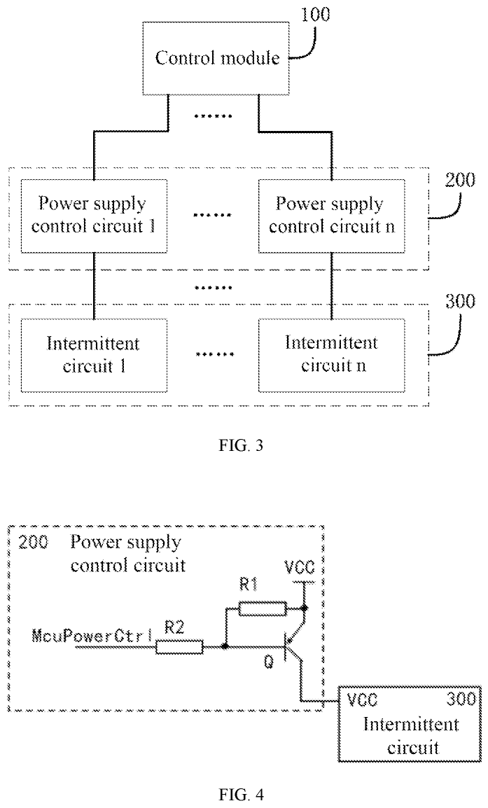

As shown in FIG. 4, the power supply control circuit 200 includes: a first resistor R1, a second resistor R2 and a triode Q.

One end of the first resistor R1 is connected to an emitter of the triode Q and a power source, and the other end of the first resistor R1 is connected to a base of the triode Q and one end of the second resistor R2; a collector of the triode Q is connected to the intermittent circuit 300, and the other end of the second resistor R2 is connected to the control module 100. A power supply voltage VCC of the intermittent circuit is outputted by the power source. MCU_PowerCtrl is an IO pin of the control module 100, and a working state of the triode Q is controlled by changing a level and a voltage on the IO pin, and then whether the power supply supplies power to a functional circuit or not is controlled.

Embodiments of the present application are further illustrated below.

A classification on functional circuits is performed to determine functional circuits that may be used for power supply scheduling as the intermittent circuits. These intermittent circuits are connected to the control module (MCU) through independent power supply control circuits. The control module may control these power supply control circuits through IO pins, so that whether the power supply supplies power to these intermittent circuits or not are controlled.

According to an output power of the intrinsically safe power supply and a power of a non-scheduling circuit, the power that may be used for scheduling is calculated, denoted as P0, as the second power.

The initial state of the intermittent circuit at the power-on reset is an inactive state; when the intermittent circuit needs to run, the intermittent circuit applies, to the power management task, for power supply and is added to the application list. The intermittent circuit runs only after the application is approved. After completion of running, the power supply request is released to the power management task, and the intermittent circuit is removed from the running queue.

The functional circuits are grouped in accordance with the timeliness of the power supply response. The higher the timeliness of the power supply response is required, the higher the priorities of functional circuits in this group; functional circuits in a same group is prioritized in accordance with the size of the power of the power supply, and the lower the power, the higher the priority.

A power-on initialization operation includes: obtaining, according to power of the power supply of the intrinsically safe power supply and the circuits of the flowmeter, the power P0 that may be used for the power supply scheduling of the functional circuits, as the second power; initializing information of each intermittent circuit, which needs to include the priority and the running power of each intermittent circuit; initializing the application list, where the initial values are null, and no intermittent circuit applies for power supply; and initializing the running queue, where the initial values are null, and no intermittent circuit is running. After the power-on reset, intermittent circuits on a hardware are all in a power off mode.

When an intermittent circuit needs to run, it applies, to the power management task, for power supply, and the power management task compares a currently available power P0 with the running power (the first power) of the intermittent circuit: if the currently available power is greater than or equal to the running power of the circuit, that is, if the second power is greater than or equal to the first power, the application for power supply is approved, the intermittent circuit is added to the running queue, the power supply switch on the hardware is turned on to supply power to the intermittent circuit, and the power of the intermittent circuit is subtracted from the currently schedulable power; if the currently available power P0 is less than the running power of the circuit, that is, the second power is less than the first power, a search is conducted in the running queue with traversal started from the circuit with the lowest priority. If there are, in the running queue, circuits with priorities low than the priority of the intermittent circuit and the intermittent circuit can be supplied with power after these running circuits are shut down, then the power supplies of these running circuits are shut down and these shut-down circuits are added to the power supply application queue, and the power supply switch on the hardware is turned on to supply power to the intermittent circuit, that is, the application for the power supply is approved, and the value of the currently schedulable power is updated. Another intermittent circuit is obtained from the application list in accordance with the priority, and the subsequent steps are performed until the application queue is empty and the traversal ends, or a query about whether or not the application queue is empty is conducted after a wait of a period of time. If there are no circuits with priorities low than the priority of the intermittent circuit in the running queue, or if there are, in the running queue, circuits with priorities low than the priority of the intermittent circuit but the intermittent circuit can not be supplied with power after these running circuits are shut down, that is, the sum of the second power and the third power is less than the first power, the intermittent circuit is then added back to the application queue, the application for the power supply is not approved, and an intermittent circuit with the priority lower than the priority of this intermittent circuit added back to the application queue is selected from the application list as a new circuit to be run, and then obtaining of the first power of this new circuit to be run and the currently available second power, as well as the subsequent steps, is performed, which will not be repeated here.

When execution of a certain running circuit in the running queue finishes, the power supply switch of this circuit is turned off, the value of the currently schedulable power is updated, and this circuit is deleted from the running queue. If the current application list is not empty, the application queue is traversed in accordance with the priority from high to low, and a judgment about whether other intermittent circuits in the application list can be supplied with power is continued until the application queue is empty or the traversal of the application queue ends.

Alternative solutions of the embodiments of the present application include: a priority of a functional circuit within a group may be defined in accordance with a length of a power supply duration; a power supply control circuit may be implemented by a CMOS tube or IO controlling an enable pin of a chip directly, or the like. A first resistor and a second resistor may be adjusted according to an actual circuit. Although the above solutions can play corresponding roles, it is more complicated to implement these solutions.

In a third aspect, a flowmeter is provided according to an embodiment of the present application, including: a constant power supply circuit and the above-mentioned circuit power supply management system for the flowmeter.

In the method of the present application, by obtaining the intermittent circuit with the highest priority in the application list as the circuit to be run, running the circuit to be run in the application list according to the currently available second power and the sum of the second power and the third power, or sequentially releasing the intermittent circuits with the priorities lower than the first priority in the running queue in accordance with the priority from low to high and then running the circuit to be run, or selecting from the application list the intermittent circuits with the priority lower than the priority of the current circuit to be run And continuing the comparison, prioritized execution of an intermittent circuit with a high priority can be realized, so that a power supply requirement of a product is met when a loading capacity of an intrinsically safe power supply is insufficient. The requirement for simultaneous running of functional circuits is met, and meanwhile there is no need to add an extra intrinsically safe power supply, the cost is low, and the circuit is simple. Through a scheduling strategy, it is ensured that circuits with a high requirement for power supply response can be responded in time, as many circuits as possible are run at a same time, and the loading capacity of the intrinsically safe power supply is fully utilized. Since there is no need to increase the number of intrinsically safe power supplies, a price of the product is more competitive, and an on-site construction wiring is more convenient.

The above is only the preferred specific embodiments of the present application, but the protection scope of the present application is not limited thereto. Changes or substitutions that can be readily thought of by those skilled in the art within the technical scope disclosed in the present application shall be covered by the protection scope of the present application. Therefore, the protection scope of the present application shall be subject to the protection scope of claims.

1. A circuit power supply management method for a flowmeter, comprising:
obtaining an intermittent circuit with a highest priority in an application list as a circuit to be run;
obtaining a first priority and a first power of the circuit to be run;
obtaining a currently available second power, and running the circuit to be run if the second power is greater than or equal to the first power, or
obtaining, from a running queue, a third power of an intermittent circuit with a priority lower than a priority of the circuit to be run if the second power is less than the first power;
running the circuit to be run if a sum of the second power and the third power is greater than or equal to the first power, or
if the sum of the second power and the third power is less than the first power, obtaining, from the application list, an intermittent circuit with a priority lower than the priority of the circuit to be run, as the circuit to be run and performing the step of obtaining the first priority and the first power of the circuit to be run.

2. The circuit power supply management method for the flowmeter according to claim 1, wherein before the obtaining the intermittent circuit with the highest priority in the application list as the circuit to be run, the method further comprises:
performing a classification on a power supply circuit in the flowmeter, the classification comprises: a constant power supply circuit and an intermittent circuit; and
prioritizing all of intermittent circuits.

3. The circuit power supply management method for a flowmeter according to claim 1, wherein the obtaining, from the running queue, the third power of the intermittent circuit with the priority lower than the priority of the circuit to be run if the second power is less than the first power comprises:
determining, from the running queue, all of intermittent circuits with priorities lower than the priority of the circuit to be run, as circuits to be calculated if the second power is less than the first power; and
determining a sum of powers of all the circuits to be calculated as the third power.

4. The circuit power supply management method for a flowmeter according to claim 1, wherein the running the circuit to be run if the sum of the second power and the third power is greater than or equal to the first power comprises:
sequentially releasing, in accordance with priority from low to high, intermittent circuits with priorities lower than the first priority in the running queue if the sum of the second power and the third power is greater than or equal to the first power; and
running the circuit to be run.

5. The circuit power supply management method for a flowmeter according to claim 1, wherein before the obtaining, from the application list, the intermittent circuit with the priority lower than the priority of the circuit to be run, as the circuit to be run, the method further comprises:
performing the step of obtaining the intermittent circuit with the highest priority in the application list as the circuit to be run if there is, in the application list, no intermittent circuit with the priority lower than the priority of the circuit to be run.

6. The circuit power supply management method for a flowmeter according to claim 1, wherein after the running the circuit to be run, the method further comprises:
deleting the circuit to be run that has been run from the application list; and
performing the step of obtaining the intermittent circuit with the highest priority in the application list as the circuit to be run.

7. The circuit power supply management method for a flowmeter according to claim 4, wherein after the sequentially releasing, in accordance with priority from low to high, the intermittent circuits with the priorities lower than the first priority in the running queue, the method further comprises:
adding the released intermittent circuits with the priorities lower than the first priority to the application list.

8. The circuit power supply management method for a flowmeter according to claim 1, wherein the intermittent circuits in the application list are sorted in accordance with their priorities from high to low;
wherein the intermittent circuits with a same priority are sorted in accordance with power from low to high.

9. A circuit power supply management system for a flowmeter, comprising: a controller, a plurality of power supply control circuits and a plurality of intermittent circuits;
the number of the power supply control circuits is the same as the number of the intermittent circuits, and the intermittent circuits are connected to the controller through the power supply control circuits; and
the controller is configured to: obtain an intermittent circuit with a highest priority in an application list as a circuit to be run, wherein intermittent circuits with a same priority are sorted in accordance with power from low to high; obtain a first priority and a first power of the circuit to be run; obtain a currently available second power, and run the circuit to be run through the power supply control circuit if the second power is greater than or equal to the first power, or obtain, from a running queue, a third power of the intermittent circuits with a priority lower than a priority of the circuit to be run, and run the circuit to be run through the power supply control circuit if a sum of the second power and the third power is greater than or equal to the first power.

10. The circuit power supply management system for a flowmeter according to claim 9, wherein the power supply control circuit comprises: a first resistor, a second resistor and a triode;
one end of the first resistor is connected to an emitter of the triode and a power source, and the other end of the first resistor is connected to a base of the triode and one end of the second resistor; and
a collector of the triode is connected to the intermittent circuit, and the other end of the second resistor is connected to the controller.

11. A flowmeter, comprising: a constant power supply circuit and the circuit power supply management system for the flowmeter according to claim 9.
